(19) United States
(12) Patent Application Publication
(10) Pub. No.: US 2026/0119575 A1
(43) Pub. Date: Apr. 30, 2026

(54) GRAPH SEARCH APPARATUS AND METHOD USING THE SAME

(71) Applicant: SOONCHUNHYANG UNIVERSITY INDUSTRY ACADEMY COOPERATION FOUNDATION, Asan-si (KR)

(72) Inventors: Im Yeong LEE, Cheonan-si (KR); Seong Cheol Yoon, Seoul (KR)

(73) Assignee: SOONCHUNHYANG UNIVERSITY INDUSTRY ACADEMY COOPERATION FOUNDATION, Asan-si (KR)

(21) Appl. No.: 19/229,141

(22) Filed: Jun. 5, 2025

(30) Foreign Application Priority Data
Oct. 28, 2024 (KR) 10-2024-0148316

(51) Int. Cl. G06F 16/901; G06F 17/10

(52) U.S. Cl. CPC G06F 16/9024; G06F 17/10

(57) ABSTRACT

The present invention relates to a graph search apparatus and a method using the same.

According to an embodiment of the present invention, the graph search apparatus comprises: a communication unit, a storage unit, and a processor operably connected to the communication unit and the storage unit, wherein the processor is configured to: receive graph data from a user device, determine a first node among nodes of the graph as a start node, store a value of the first node in a queue, determine at least one of adjacent nodes of the first node as a second node for search, and determine whether to store the second node in the queue based on the value stored in the queue and a value of the second node.

This application claims priority from and the benefit of Korean Patent Application No. 10- 2024-0148316 filed on October 28, 2024, in the Korean Intellectual Property Office, the disclosure of which is incorporated herein by reference.

### BACKGROUND OF THE DISCLOSURE

### Field of the Disclosure

Example embodiments relate to a graph search apparatus and a method using the same, and more particularly, to a graph search apparatus and a method using the same for preventing a tottering phenomenon in which specific nodes are alternately searched.

### Description of the Related Art

A method for comparing similarity between two graphs has existed, in which an AI is trained to compare structural similarities of graphs, and a graph similarity inspection tool compares the structural similarities of the graphs using the trained AI.

In this case, such AI-based graph similarity inspection tools have the advantage of efficiently recognizing complex patterns.

However, AI-based graph similarity inspection tools require a preprocessing step for the graphs to train the AI model, and this preprocessing may result in the loss of structural information of the graphs, thereby causing a degradation in the performance of the model.

To address this issue, graph edit distance algorithms have been used. A graph edit distance algorithm is one of the algorithms used to compare the similarity between two graphs.

In this case, the graph edit distance algorithm may perform graph search to compare similarities between graphs.

However, due to the NP-hard nature of the problem, there exists a limitation in efficiently using the graph edit distance algorithm.

### SUMMARY

Accordingly, the present invention has developed a heuristic algorithm for graph edit distance based on a k-walk, which performs a search up to a length k and derives an approximate value of the graph edit distance.

In particular, the inventors of the present invention have devised a k-walk-based graph search apparatus that prevents a tottering phenomenon by excluding a search node when the number of values stored in the queue is two or more and the first stored value in the queue is identical to the search node.

To this end, the present invention provides a graph search apparatus and a method using the same, the apparatus comprising a communication unit configured to receive at least two graphs and a k value, a storage unit, and a processor operably connected to the communication unit and the storage unit, wherein the processor is configured to receive graph data from a user device, determine a first node among nodes of the graph as a start node, store a value of the first node in a queue, determine at least one of adjacent nodes of the first node as a second node for search, and determine whether to store the second node in the queue based on the value stored in the queue and a value of the second node.

The objectives of the present invention are not limited to those described above, and other objectives that are not explicitly mentioned will be clearly understood by those skilled in the art from the following detailed description.

According to an embodiment of the present invention, a graph search apparatus may comprise a communication unit, a storage unit, and a processor operably connected to the communication unit and the storage unit, wherein the processor may be configured to receive graph data from a user device, determine a first node among nodes of the graph as a start node, store a value of the first node in a queue, determine at least one of adjacent nodes of the first node as a second node for search, and determine whether to store the second node in the queue based on the value stored in the queue and a value of the second node.

According to another aspect of the present invention, the graph data may comprise a graph, structure data of the graph, and search distance data.

According to another aspect of the present invention, the processor may be configured to store the value of the second node in the queue when a number of values stored in the queue is less than a threshold value.

According to still another aspect of the present invention, the processor may be configured to determine whether the value of the second node is identical to a value stored in the queue when the number of values stored in the queue is equal to or greater than a threshold value.

According to still another aspect of the present invention, the processor may be configured to refrain from storing the value of the second node in the queue when the value of the second node is identical to a value stored in the queue.

According to still another aspect of the present invention, the processor may be configured to store the value of the second node in the queue when the value of the second node is not identical to any value stored in the queue.

According to an embodiment of the present invention, a graph search method implemented by a processor may comprise: receiving graph data from a user device, determining a first node among nodes of the graph as a start node, storing a value of the first node in a queue, determining at least one of adjacent nodes of the first node as a second node for search, and determining whether to store the second node in the queue based on a value stored in the queue and a value of the second node.

According to another aspect of the present invention, the graph data may comprise a graph, structure data of the graph, and search distance data.

According to another aspect of the present invention, the determining whether to store the second node in the queue may comprise: storing the value of the second node in the queue when a number of values stored in the queue is less than a threshold value.

According to still another aspect of the present invention, the determining whether to store the second node in the queue may further comprise: determining whether the value of the second node is identical to a value stored in the queue when a number of values stored in the queue is equal to or greater than the threshold value.

According to still another aspect of the present invention, the determining whether the value of the second node is identical to a value stored in the queue may comprise: refraining from storing the value of the second node in the queue when the value of the second node is identical to a value stored in the queue.

According to still another aspect of the present invention, the determining whether the value of the second node is identical to a value stored in the queue may comprise: storing the value of the second node in the queue when the value of the second node is not identical to any value stored in the queue.

According to the present invention, it is possible to prevent a tottering phenomenon during node search by detecting duplicate visits using a queue, thereby preventing the generation of unnecessary k-walks and reducing the execution time of the algorithm.

In addition, by detecting duplicate visits using a queue during node search, the present invention can prevent unnecessary k-walks from being generated, so that no additional edit cost occurs when deriving an approximate value of the graph edit distance, thereby improving the accuracy of the approximation.

The effects of the present invention are not limited to the examples described above, and various other effects are also encompassed within the scope of the present invention.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a block diagram of a graph search apparatus according to an embodiment of the present invention.

FIG. 2 is an exemplary diagram of a graph input to the graph search apparatus according to an embodiment of the present invention.

FIG. 3 is a flowchart illustrating the graph search apparatus and a user device according to an embodiment of the present invention.

FIG. 4 is a flowchart illustrating node search in the graph search apparatus according to an embodiment of the present invention.

FIG. 5 is a flowchart of a graph search method according to an embodiment of the present invention.

FIG. 6 is a graph illustrating the amount of k-walk generation of a conventional graph search apparatus and the graph search apparatus of the present invention.

FIG. 7 is a graph illustrating the k-walk generation time of a conventional graph search apparatus and the graph search apparatus of the present invention.

### DETAILED DESCRIPTION OF THE DISCLOSURE

The specific structural or functional descriptions of embodiments according to the concept of the present invention disclosed in this specification are merely illustrative and are provided for the purpose of explaining the embodiments based on the concept of the present invention. The embodiments based on the concept of the present invention may be implemented in various forms and are not limited to the embodiments described herein.

Various modifications and variations may be made to the embodiments based on the concept of the present invention. While embodiments are illustrated in the drawings and described in detail in the specification, it is not intended to limit the embodiments to specific disclosed forms. Rather, the embodiments should be construed to include modifications, equivalents, and substitutions that fall within the spirit and scope of the invention.

The terms “first,” “second,” and the like may be used to describe various elements, but such terms should not be construed as limiting. These terms are only used to distinguish one element from another. For example, within the scope of the present invention, a first element may be referred to as a second element, and similarly, a second element may be referred to as a first element without departing from the scope of the invention.

When an element is referred to as being “connected to” or “coupled to” another element, it may be directly connected or coupled to the other element or may be indirectly connected or coupled via one or more intervening elements. In contrast, when an element is referred to as being “directly connected to” or “directly coupled to” another element, it should be understood that there are no intervening elements between them. Similar interpretations apply to expressions that describe relationships between elements, such as “between,” “immediately between,” and “adjacent to.”

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Furthermore, the terms “comprise,” “have,” and any variations thereof, are intended to denote the presence of stated features, integers, steps, operations, elements, components, or combinations thereof, but do not preclude the presence or addition of one or more other features, integers, steps, operations, elements, components, or combinations thereof.

Unless otherwise defined, all terms including technical and scientific terms used herein have the same meaning as commonly understood by one of ordinary skill in the art to which the invention pertains. Terms that are generally defined in commonly used dictionaries should be interpreted as having a meaning consistent with their meaning in the context of the relevant art and the present disclosure, and are not to be interpreted in an idealized or overly formal sense unless expressly so defined herein.

Hereinafter, embodiments will be described in detail with reference to the accompanying drawings. However, the scope of the present application is not limited or restricted by these embodiments. Like reference numerals refer to like elements throughout the drawings.

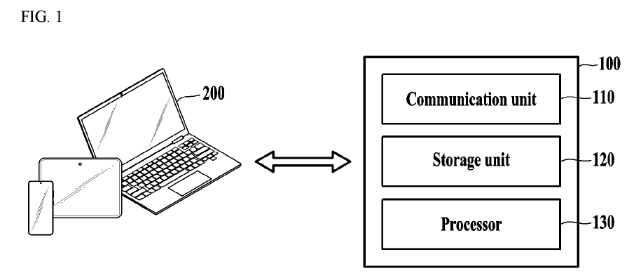

FIG. 1 is a block diagram of a graph search apparatus according to an embodiment of the present invention.

Referring to FIG. 1, a graph search apparatus 100 may comprise a communication unit 110, a storage unit 120, and a processor 130 operably connected to the communication unit and the storage unit.

The graph search apparatus 100 may be configured to receive graph data from a user device 200. The graph data may comprise a graph, structure data of the graph, and search distance data (a k value). The structure data of the graph may be a set of nodes and edges included in the graph.

The graph search apparatus 100 may receive two graphs to be used for similarity comparison. The two graphs may be of the same type. For example, the two graphs may be either complete graphs or connected graphs, but are not limited thereto.

The graph search apparatus 100 may generate k-walks for the received graphs using a k-walk-based graph edit distance heuristic algorithm. In this case, the graph search apparatus 100 may prevent re-searching of nodes based on a data structure such as a queue.

The graph search apparatus 100 may generate k-walks based on a k-walk-based graph edit distance heuristic algorithm using a graph as input. In this case, the graph search apparatus 100 may search for a path that visits k nodes starting from a specific node. Through this, the graph search apparatus 100 may explore the structure of the graph.

The graph search apparatus 100 may detect duplicate visits through a data structure such as a queue. Specifically, the graph search apparatus 100 may determine whether the number of values stored in the queue is equal to or greater than a threshold value and may determine whether to store search node information in the queue. When the number of values stored in the queue is equal to or greater than the threshold value, the graph search apparatus 100 may determine whether the first stored value in the queue is identical to the current search node, and based on the result, determine whether to store the search node in the queue. The threshold value may be set to 2, although it is not limited thereto.

Accordingly, the present invention can prevent a tottering phenomenon by detecting duplicate visits using a queue during node search, thereby preventing the generation of unnecessary k-walks and reducing the execution time of the algorithm.

In addition, the present invention can prevent the generation of unnecessary k-walks by detecting duplicate visits using a queue during node search. As a result, when deriving an approximate value of the graph edit distance, no additional edit cost is incurred, and the accuracy of the approximation can be improved.

The communication unit 110 may be connected to a user device 200 via a wired or wireless communication network and may transmit and receive data. In this case, the communication unit 110 may receive a graph search request from the user device 200. Here, the communication unit 110 may receive data required to perform the above-described request from the user device 200. For example, to perform the graph search request, the communication unit 110 may receive graph data from the user device 200. The graph data may comprise a graph, structure data of the graph, and search distance data.

The communication unit 110 may also transmit a k-walk, which is a result corresponding to the graph search request of the user device 200.

The communication unit 110 may comprise a wired communication port or a wireless circuit. The wired communication port may include one or more wired interfaces, such as Ethernet, Universal Serial Bus (USB), or FireWire. The wireless circuit may transmit and receive data with an external device using RF signals or optical signals. Furthermore, the wireless communication may employ at least one of a plurality of communication standards, protocols, and technologies, such as Zigbee, GSM, EDGE, CDMA, TDMA, Bluetooth, Wi-Fi, VoIP, WiMAX, or any other suitable communication protocol.

The storage unit 120 may store various types of data used by the graph search apparatus 100. The stored data may include the graph edit distance heuristic algorithm, graph data received from a user device, user device information, and values stored in a queue.

In various embodiments, the storage unit 120 may include a volatile or non-volatile recording medium capable of storing data, commands, and information. For example, the storage unit 120 may include at least one type of storage medium such as flash memory, hard disk, micro-type multimedia card, card-type memory (e.g., SD or XD memory), RAM, SRAM, ROM, EEPROM, PROM, network-attached storage, cloud storage, or a blockchain-based database.

The processor 130 may be connected to the communication unit 110 and the storage unit 120 and may control the overall operation of the graph search apparatus and the method using the same.

The processor 130 may be a computing device such as a Central Processing Unit (CPU) or an Application Processor (AP). In some embodiments, the processor 130 may be implemented in the form of an integrated chip such as a System on Chip (SoC) that integrates various processing components. Additionally, the processor 130 may include a module for computing artificial neural network models, such as a Neural Processing Unit (NPU).

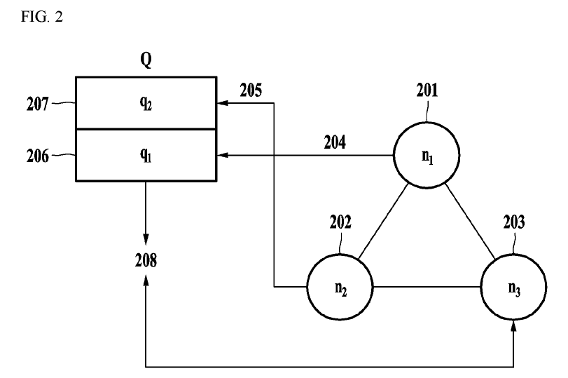

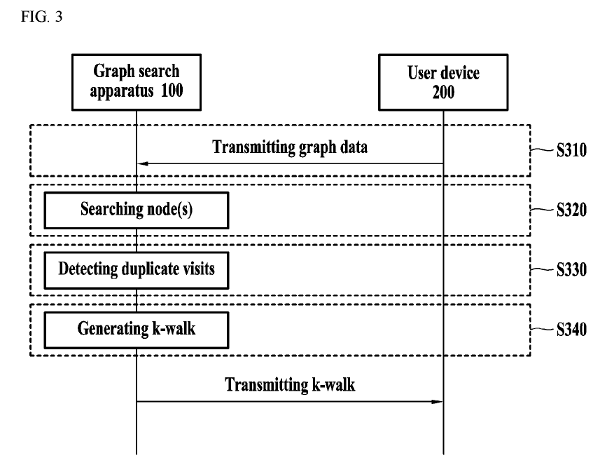

FIG. 2 is an exemplary diagram of a graph input to the graph search apparatus according to an embodiment of the present invention, and FIG. 3 is a flowchart illustrating the graph search apparatus and a user device according to an embodiment of the present invention.

In step 1 (S310), the graph search apparatus 100 may receive a graph search request from the user device 200. In this case, the graph search apparatus 100 may receive graph data. The graph data may comprise a graph, structure data of the graph, and search distance data. Here, the structure data of the graph may include data on nodes and edges contained in the graph.

The graph input to the graph search apparatus may comprise nodes and edges. For example, the graph may include a first node 201, a second node 202, and a third node 203. Here, an edge may represent a line connecting two nodes.

The graph may be a directed graph or an undirected graph. In the case of a directed graph, an edge from the first node 201 to the second node 202 and an edge from the second node 202 to the first node 201 may be recognized as different edges. In contrast, in the case of an undirected graph, the edge between the first node 201 and the second node 202 may be considered the same as the edge between the second node 202 and the first node 201.

In addition, the search distance data may be a search length value (k value) for searching the graph. The k value may be lower than the number of nodes in the smaller of the two graphs. For example, when the graph search apparatus 100 receives a search request for an arbitrary graph, the k value may be received as a value smaller than the number of nodes in the graph. Preferably, the k value may be received as one less than the number of nodes in the graph.

Next, the graph search apparatus 100 may search the nodes of the received graph in step 2 (S320). The graph search apparatus 100 may set each node of the graph as a start node. The graph search apparatus 100 may search for adjacent nodes of the start node. For example, adjacent nodes of the first node 201 may include the second node 202 and the third node 203. The graph search apparatus 100 may determine one of the adjacent nodes of the start node as a second node for search. In this case, the graph search apparatus 100 may determine the node with the smallest index number among the adjacent nodes of the start node as the second node. For example, the second node 202 may be selected as the search node for the first node 201.

Next, the graph search apparatus 100 may detect duplicate visits of nodes in step 3 (S330). The graph search apparatus 100 may detect duplicate visits of nodes using a data structure such as a queue. The graph search apparatus 100 may perform a first-level classification based on whether the number of values stored in the queue is equal to or greater than two. If the number of values stored in the queue is less than two, the graph search apparatus 100 may store (enqueue) the value of the searched node in the queue. On the other hand, if the number of values stored in the queue is equal to or greater than two, the graph search apparatus 100 may determine whether the first stored value in the queue is identical to the value of the search node. If the value of the first stored item in the queue is identical to the value of the search node, the graph search apparatus 100 may refrain from storing the searched node in the queue. If the value of the first stored item in the queue is not identical to the value of the search node, the graph search apparatus 100 may store the searched node in the queue.

For example, the graph search apparatus 100 may search the first node 201. At this time, the queue Q may not contain any node information, and the number of values stored in the queue may be zero. Accordingly, the graph search apparatus 100 may store the value of the first node 201 as q1 206 (operation 204).

The graph search apparatus 100 may then search the second node 202, which is an adjacent node of the first node 201. In this case, the queue may be Q = (q1), and the number of values stored in the queue may be one. Accordingly, the graph search apparatus 100 may store the value of the second node 202 as q2 207 (operation 205).

The graph search apparatus 100 may determine the first node 201, which is an adjacent node of the second node 202, as a node for search. Then, the graph search apparatus 100 may search the first node 201 again. At this time, the queue may be Q = (q1 206, q2 207), where the value of q1 206 is n1 and the value of q2 207 is n2. Since q1 and q2 are both stored, the number of values stored in the queue may be two. Accordingly, the graph search apparatus 100 may determine whether the value of the node to be searched is identical to the value of the first stored item in the queue. Here, the first stored value q1 206 may be n1, which may be identical to the value of the first node 201. Therefore, the graph search apparatus 100 may refrain from storing the value of the first node 201 in the queue.

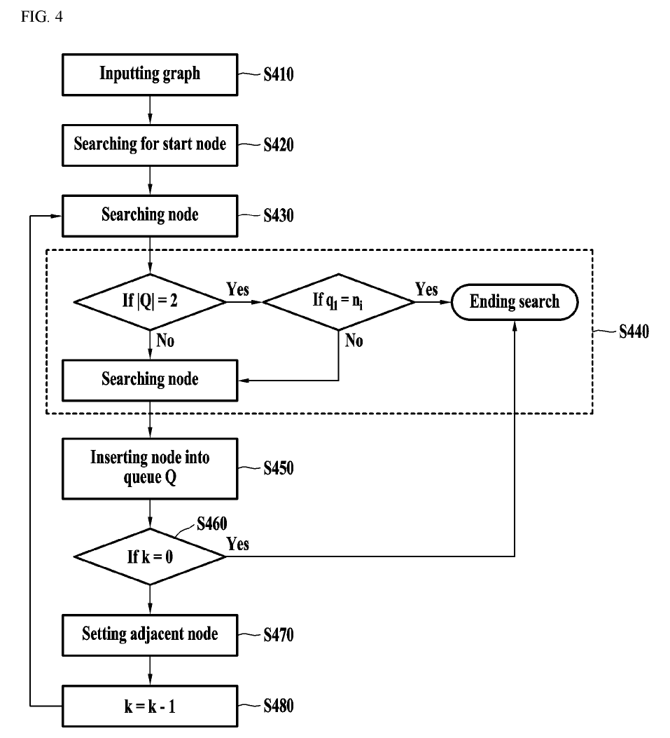

The graph search apparatus 100 may then determine the third node 203, which is another adjacent node of the second node 202, as the node for search. The graph search apparatus 100 may search the third node 203. At this time, the queue may remain Q = (q1 206, q2 207), where the value of q1 206 is n1 and the value of q2 207 is n2. As the queue still contains q1 and q2, the number of stored values may remain two. Accordingly, the graph search apparatus 100 may determine whether the value of the third node 203 is identical to the value of the first stored item in the queue. In this case, the value of the first stored item q1 206 is n1, which may not be identical to the value of the third node 203. Therefore, the graph search apparatus 100 may store the value of the third node 203 in the queue. After storing the value of the third node 203, the stored values in the queue may be updated so that q1 206 becomes n2 and q2 207 becomes n3. Further details will be described with reference to FIG. 4.

Next, the graph search apparatus 100 may generate a k-walk in step 4 (S340). In this case, the graph search apparatus 100 may generate the k-walk when the search from the start node is completed k times. Here, the k-walk may be a set composed of a sequence of k+1 nodes. For example, the k-walk w may be represented as w = {n1, n2, n3, ..., nk+1}.

FIG. 4 is a flowchart illustrating node search performed by the graph search apparatus according to an embodiment of the present invention.

First, the graph search apparatus 100 receives a graph as input (S410). In this step, the graph search apparatus 100 may receive graph data. The graph data may comprise a graph, structure data of the graph, and search distance data. For example, the structure data of the graph may include node information such as n1, n2, n3, ..., ni, and edge information such as (n1, n2), (n1, n3), ..., (ni−1, ni).

Next, the graph search apparatus 100 searches for a start node (S420). For example, the graph search apparatus 100 may determine the first node n1 as the start node.

Then, the graph search apparatus 100 searches a node (S430). In this step, the graph search apparatus 100 may determine a search node as the neighbor node having the smallest index number. Here, a neighbor node may refer to a node connected to the current node by an edge. For example, if the received edge information includes (n1, n2), (n1, n3), ..., (n1, ni), the graph search apparatus 100 may determine n2, n3, ..., ni as neighbor nodes of n1. Furthermore, when the current node is n1, the graph search apparatus 100 may determine n2, which has the smallest index number among the neighbor nodes, as the search node.

At this point, the graph search apparatus 100 may check the number of values stored in the queue, and if the number is less than two, may enqueue the start node. For example, when the current number of values stored in the queue is zero, the graph search apparatus 100 may store n1 in the queue. As a result, the queue may be Q = (n1).

Next, the graph search apparatus 100 determines whether to store the search node in the queue based on the number of values stored in the queue and whether the search node is identical to the first stored value in the queue (S440), and based on the determination result, stores the search node in the queue (S450).

In this case, when the number of values stored in the queue is equal to or greater than two, the graph search apparatus 100 may determine whether the value of the search node is identical to the first value stored in the queue. If the value of the search node is identical to the first stored value in the queue, the graph search apparatus 100 may refrain from storing the search node. If the value of the search node is not identical to the first stored value in the queue, the graph search apparatus 100 may store the search node in the queue. On the other hand, when the number of values stored in the queue is less than two, the graph search apparatus 100 may store the search node in the queue.

For example, if the start node is n1 and the search node is n2, the current queue may be Q = (n1), and the number of values stored in the queue may be one. Since the number of stored values in the queue is less than two, the graph search apparatus 100 may store the value of the search node n2 in the queue. As a result, the queue may be updated to Q = (n1, n2). The graph search apparatus 100 may then determine the neighbor node of n2 with the smallest index number as the next search node.

As another example, after the above process, if the current node is n2 and the search node is n1, the current queue may be Q = (n1, n2), and the number of values stored in the queue may be two. Since the number of stored values is equal to or greater than two, the graph search apparatus 100 may determine whether the value of the search node is identical to the first stored value q1 in the queue. In this case, since the first value stored in the queue is n1, which is identical to the value of the search node, the graph search apparatus 100 may refrain from storing the search node n1, and instead determine another neighbor node as the next search node.

As another example, after the foregoing example is performed, when the current node is n2 and the search node is n3, the current queue may be Q = (n1, n2), and the number of values stored in the queue may be two. In this case, since the number of values stored in the queue is equal to or greater than two, the graph search apparatus 100 may determine whether the value of the search node is identical to the first value stored in the queue, q1. Here, since the first value stored in the queue is n1, which is not identical to the search node, the graph search apparatus 100 may store the value of the search node n3 in the queue. Accordingly, the state of the queue may be updated to Q = (n2, n3). The graph search apparatus 100 may then determine the neighbor node of n3 having the smallest index number as the next search node.

Next, the graph search apparatus 100 determines whether to proceed with the search based on whether the k value is zero (S460). If the k value is zero, the graph search apparatus 100 may terminate the search. On the other hand, if the k value is not zero, the graph search apparatus 100 may proceed to the next step.

Next, the graph search apparatus 100 sets a neighbor node (S470). At this point, the graph search apparatus 100 may set a neighbor node of the search node that was stored in step 450.

Subsequently, the graph search apparatus 100 decrements the k value by one and repeats step 430 (S460). By decrementing the k value one by one, the graph search apparatus 100 may reduce the search distance in the graph.

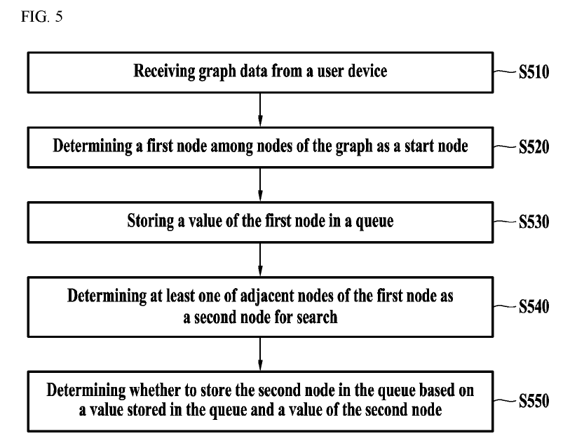

FIG. 5 is a flowchart illustrating a graph search method according to an embodiment of the present invention.

The graph search method may be implemented by a processor.

The processor receives graph data from a user device (S510).

Next, the processor determines one of the nodes as a first node, which serves as a start node (S520).

Subsequently, the processor stores the value of the first node in a queue (S530).

The processor then determines at least one of the adjacent nodes of the first node as a second node for search (S540).

Next, the processor determines whether to store the second node in the queue based on the values stored in the queue and the second node (S550).

In this step, if the number of values stored in the queue is less than a threshold, the processor may store the value of the second node in the queue. The threshold may be set to a value greater than two, but preferably, it may be two.

If the number of values stored in the queue is equal to or greater than the threshold, the processor may determine whether the value of the second node is identical to a value stored in the queue. The value stored in the queue may refer to the first stored value.

If the value of the second node is identical to the first stored value in the queue, the processor may refrain from storing the second node in the queue. On the other hand, if the value of the second node is not identical to the first stored value in the queue, the processor may store the value of the second node in the queue.

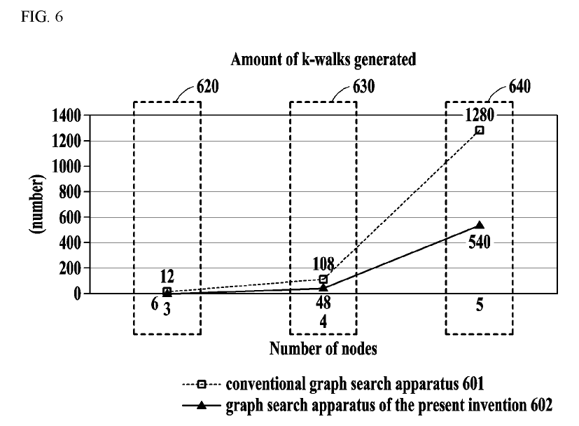

FIG. 6 is a graph illustrating the amount of k-walks generated by a conventional graph search apparatus and the graph search apparatus according to an embodiment of the present invention.

In the graph representing the amount of k-walk generation between the conventional graph search apparatus and the graph search apparatus of the present invention, the X-axis may represent the number of nodes, and the Y-axis may represent the amount of k-walks (i.e., the number of generated k-walks). When the number of nodes is three (620), the conventional graph search apparatus 601 may generate 12 k-walks, whereas the graph search apparatus 602 according to the present invention may generate 6 k-walks. Thus, when the number of nodes is small, the difference in k-walk generation between the conventional graph search apparatus 601 and the graph search apparatus 602 of the present invention is not significant.

In contrast, when the number of nodes is four (630), the conventional graph search apparatus 601 may generate 108 k-walks, while the graph search apparatus 602 of the present invention may generate 48 k-walks. Additionally, when the number of nodes is five (640), the conventional graph search apparatus 601 may generate 1,280 k-walks, whereas the graph search apparatus 602 of the present invention may generate 540 k-walks.

Accordingly, it can be seen that, in the graph search apparatus 602 of the present invention, the increase in the number of k-walks in accordance with the increase in the number of nodes differs significantly from that of the conventional graph search apparatus 601. Therefore, by preventing a tottering phenomenon during node traversal, the present invention may reduce the number of generated k-walks as compared to the conventional graph search apparatus.

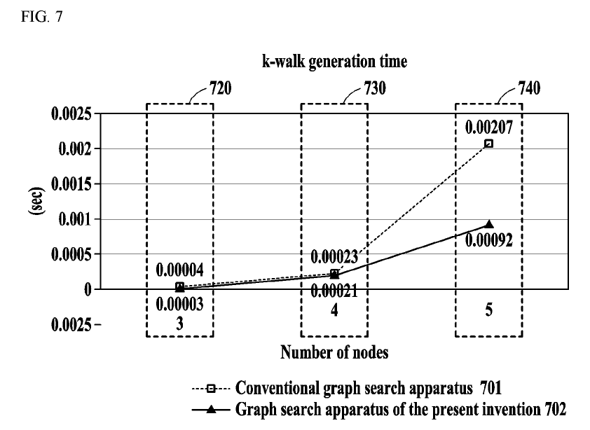

FIG. 7 is a graph illustrating the k-walk generation time of a conventional graph search apparatus and the graph search apparatus according to an embodiment of the present invention.

In the graph comparing the k-walk generation time between the conventional graph search apparatus and the graph search apparatus of the present invention, the X-axis may represent the number of nodes, and the Y-axis may represent the generation time (in seconds). When the number of nodes is three (720), the conventional graph search apparatus 701 may take 0.00004 seconds to generate k-walks, while the graph search apparatus 702 of the present invention may take 0.00003 seconds. Accordingly, when the number of nodes is small, the difference in k-walk generation time between the conventional graph search apparatus 701 and the graph search apparatus 702 of the present invention is not significant.

In contrast, when the number of nodes is four (730), the conventional graph search apparatus 701 may take 0.00023 seconds to generate k-walks, whereas the graph search apparatus 702 of the present invention may take 0.00021 seconds. In addition, when the number of nodes is five (740), the conventional graph search apparatus 701 may take 0.00207 seconds to generate k-walks, while the graph search apparatus 702 of the present invention may take 0.00092 seconds.

Accordingly, it can be seen that the increase in k-walk generation time relative to the increase in the number of nodes is significantly different between the graph search apparatus 702 of the present invention and the conventional graph search apparatus 701. Therefore, by preventing the tottering phenomenon during graph traversal, the present invention may reduce the k-walk generation time compared to the conventional graph search apparatus.

The apparatus described above may be implemented using hardware components, software components, or a combination of hardware and software components. For example, the apparatuses and components described in the embodiments may be implemented using one or more general-purpose computers or special-purpose computers such as a processor, controller, arithmetic logic unit (ALU), digital signal processor (DSP), microcomputer, field programmable array (FPA), programmable logic unit (PLU), microprocessor, or any other device capable of executing and responding to instructions. The processing device may execute an operating system (OS) and one or more software applications running on the operating system. The processing device may also access, store, manipulate, process, and generate data in response to the execution of software.

For ease of understanding, a processing device may be described as a single unit; however, those skilled in the art will appreciate that the processing device may include multiple processing elements and/or multiple types of processing elements. For example, the processing device may include multiple processors or a processor and a controller. Additionally, other processing configurations such as parallel processors may also be used.

Software may include a computer program, code, instructions, or a combination of one or more thereof and may configure a processing device to operate in a desired manner or instruct the processing device individually or collectively. The software and/or data may be embodied permanently or temporarily in any type of machine, component, physical device, virtual equipment, computer-readable storage medium or device, or propagated signal wave to be interpreted by or to provide instructions or data to the processing device. The software may be distributed over networked computer systems and may be stored or executed in a distributed manner. The software and data may be stored on one or more computer-readable recording media.

A method according to an embodiment may be implemented as a form of program instructions executable through various computer means and recorded on a computer-readable medium. The computer-readable medium may include program instructions, data files, data structures, or a combination thereof. The program instructions recorded on the medium may be specially designed and configured for the embodiments or may be well known and available to those skilled in the field of computer software.

Examples of computer-readable recording media include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. The program instructions may include not only machine language code generated by a compiler but also high-level language code that can be executed by a computer using an interpreter or the like. The above-described hardware devices may be configured to operate as one or more software modules to perform the operations of the embodiments, and vice versa.

While the embodiments have been described with reference to limited drawings, it will be understood by those skilled in the art that various modifications and variations can be made from the above disclosure. For example, the described techniques may be performed in a different order than that described, and/or components of the described systems, structures, devices, circuits, etc., may be combined or rearranged in different configurations, or replaced or substituted with other components or equivalents to achieve similar results.

Therefore, other implementations, embodiments, and equivalents to the following claims are within the scope of the appended claims.

What is claimed is:

1. A graph search apparatus comprising:
a communication unit;
a storage unit; and
a processor operably connected to the communication unit and the storage unit,
wherein the processor is configured to:
receive graph data from a user device;
determine a first node among nodes of the graph as a start node;
store a value of the first node in a queue;
determine at least one of adjacent nodes of the first node as a second node for search; and
determine whether to store the second node in the queue based on the value stored in the queue and a value of the second node.

2. The graph search apparatus of claim 1,
wherein the graph data comprises a graph, structure data of the graph, and search distance data.

3. The graph search apparatus of claim 1,
wherein the processor is configured to store the value of the second node in the queue when a number of values stored in the queue is less than a threshold value.

4. The graph search apparatus of claim 3,
wherein the processor is configured to determine whether the value of the second node is identical to a value stored in the queue when a number of values stored in the queue is equal to or greater than a threshold value.

5. The graph search apparatus of claim 4,
wherein the processor is configured to refrain from storing the value of the second node in the queue when the value of the second node is identical to a value stored in the queue.

6. The graph search apparatus of claim 4,
wherein the processor is configured to store the value of the second node in the queue when the value of the second node is not identical to any value stored in the queue.

7. A graph search method implemented by a processor, the method comprising:
receiving graph data from a user device;
determining a first node among nodes of the graph as a start node;
storing a value of the first node in a queue;
determining at least one of adjacent nodes of the first node as a second node for search; and
determining whether to store the second node in the queue based on a value stored in the queue and a value of the second node.

8. The graph search method of claim 7,
wherein the graph data comprises a graph, structure data of the graph, and search distance data.

9. The graph search method of claim 7,
wherein the determining whether to store the second node in the queue comprises:
storing the value of the second node in the queue when a number of values stored in the queue is less than a threshold value.

10. The graph search method of claim 7,
wherein the determining whether to store the second node in the queue further comprises:
determining whether the value of the second node is identical to a value stored in the queue when a number of values stored in the queue is equal to or greater than a threshold value.

11. The graph search method of claim 10,
wherein the determining whether the value of the second node is identical to a value stored in the queue comprises:
refraining from storing the value of the second node in the queue when the value of the second node is identical to a value stored in the queue.

12. The graph search method of claim 10,
wherein the determining whether the value of the second node is identical to a value stored in the queue comprises:
storing the value of the second node in the queue when the value of the second node is not identical to any value stored in the queue.
